(19) United States
(12) Patent Application Publication
(10) Pub. No.: US 2022/0048251 A1
(43) Pub. Date: Feb. 17, 2022

(54) 3D PRINTER

(71) Applicants: WONKWANG E&TECH CO., LTD., Jeollabuk-do (KR); CONCEPTION CO., LTD., Gyeongsangbuk-do (KR)

(72) Inventors: Dong Geun Lee, Jeollabuk-do (KR); Byeong Cheol Baek, Jeollabuk-do (KR); Goo Sang Jung, Gyeongsangbuk-do (KR)

(21) Appl. No.: 17/496,114

(22) Filed: Oct. 7, 2021

Related U.S. Application Data
(62) Division of application No. 16/307,987, filed on Dec. 7, 2018.

(30) Foreign Application Priority Data
Nov. 24, 2017 (KR) 10-2017-0158177
Nov. 24, 2017 (KR) 10-2017-0158178
Nov. 24, 2017 (KR) 10-2017-0158179

(51) Int. Cl. B29C 64/295; B33Y 30/00; B33Y 40/00; B33Y 50/02; B29C 64/321; B29C 64/393; B29C 64/35; B22F 12/17; B22F 10/85; B22F 12/50; B22F 12/13; B28B 1/00

(52) U.S. Cl. CPC B29C 64/295; B33Y 30/00; B33Y 40/00; B33Y 50/02; B29C 64/321; B28B 1/001; B29C 64/35; B22F 12/17; B22F 10/85; B22F 12/50; B22F 12/13; B29C 64/393

(57) ABSTRACT

Disclosed is 3D printer that may precisely irradiate a laser to a spot where the laser is to be irradiated so that a precise three-dimensional product may be output, and prevent a temperature deviation from occurring inside a case including a product forming chamber to improve the quality of the output product, and increase the durability of the output product by enhancing the binding force between powder and powder applied to an output bed and maximizing the melting of the powder.

### CROSS REFERENCES TO RELATED APPLICATIONS

This application is a divisional of Dong Geun Lee et al., U.S. patent application Ser. No. 16/307,987 filed on Dec. 7, 2018, entitled “3D PRINTER”, which claims the priority of Korean Patent Application Nos. 10-2017-0158177, filed on Nov. 24, 2017, 10-2017-0158178, filed on Nov. 24, 2017, and 10-2017-0158179, filed on Nov. 24, 2017 in the KIPO (Korean Intellectual Property Office), the disclosure of which is incorporated herein entirely by reference. Further, this application is the National Stage application of International Application No. PCT/KR2017/013768, filed on Nov. 29, 2017, which designates the United States and was published in Korean. Each of these applications is hereby incorporated by reference in their entirety into the present application.

### TECHNICAL FIELD

The present disclosure relates to a 3D printer, and more particularly, to a 3D printer that may precisely irradiate a laser to a spot where the laser is to be irradiated so that a precise three-dimensional product may be output, and prevent a temperature deviation from occurring inside a case including a product forming chamber to improve the quality of the output product, and increase the durability of the output product by enhancing the binding force between powder and powder applied to an output bed and maximizing the melting of the powder.

### BACKGROUND ART

Recently, a so-called 3D printing method in which a product designer and planner creates 3D modeling data by using CAD or CAM and produces a prototype of a 3D stereoscopic shape by using the generated data has emerged. Such a 3D printer is utilized in a variety of fields such as industries, daily life, medicines, and so on.

The basic principle of a typical 3D printer is to build a 3D object by stacking thin 2D layers.

Depending on printing methods, the 3D printer is classified into four technologies, namely FDM (Fused Deposition Modeling), DLP (Digital Light Processing), SLA (Stereolithography Apparatus) and SLS (Selective Laser Sintering). Also, a variety of materials such as ceramics, plastic, metal and resin are used as materials of the 3D printer.

In the FDM method, a wire-shaped filament made of a thermoplastic resin is supplied to form a target object in a two-dimensional plane shape so that the two-dimensional planes are stacked to form a 3D shape, and the supplied filament is melted and stacked through a nozzle to shape the object three-dimensionally. This technique is disclosed in Korean Unexamined Patent Publication No. 10-2015-0134186 and the like.

The SLS method uses a functional polymer or a metal powder and is a technique for forming an object by sintering the functional polymer or metal powder by irradiating laser. The SLA method uses a principle that a light is irradiated to a photo-curable resin so that the irradiated portion is cured.

The DLP method uses the principle that a photo-curable resin is cured in response to light, like the SLA method, and it is a technique to irradiate a beam projecting to the photo-curable resin to form an object.

Meanwhile, in the case where 3D printing is performed using a laser as in the SLS method, it is important that the laser should be irradiated to an accurate spot.

This is because a three-dimensional molding may be output more elaborately as the laser is irradiated to a proper spot more precisely.

In addition, if the irradiation precision of the laser is lowered, the shaped product is roughly molded and thus the quality of the output product is lowered. For this reason, the precision of the laser irradiation is particularly important.

However, a laser irradiation device used in the conventional SLS-type 3D printer is fixed to an upper center of an outer case and adjusts an irradiation path of laser by a galvanometer, a reflecting mirror or the like so that the laser is irradiated only to a required location. This process however may easily cause an error, for example an error that a circular spot of a light beam irradiated to an output plate is distorted.

Moreover, in the conventional SLS-type 3D printer, a temperature deviation occurs in the case including a product forming chamber for forming a product, and thus a formed and outputted product may be twisted or cracked due to heat shrinkage or the like.

Meanwhile, in the conventional SLS-type 3D printer, after a powder material is applied, the laser is selectively irradiated to the material to melt the powder. Then, the process of coating the powder material on one layer and then irradiating the laser is repeated, thereby outputting a formed product.

However, in the conventional SLS method, the material in a powder form is uniformly applied to the bed, and also the density of the dispersed powder is very low. That is, since different amounts of the powder are dispersed in various regions, when a formed product is prepared using a laser, its surface state may not be precisely formed, and a lot of void spaces are formed between the powder and the powder, thereby deteriorating the durability of the formed product.

### DISCLOSURE OF THE INVENTION

### Technical Problem

The present disclosure is designed to solve various conventional problems as above, and the present disclosure is directed to providing a 3D printer having a variable laser irradiation device, which may allow a laser to be irradiated to an accurate spot so that an elaborate three-dimensional product may be output.

The present disclosure is also directed to provide a 3D printer having a heating device, which may improve the quality of a formed product so that a temperature deviation is not generated in a case including a product forming chamber for forming a product.

The present disclosure is also directed to provide a 3D printer having a binder jetting unit, which may enhance the durability of an outputted product by reinforcing the binding force between powder and powder applied to an output bed and maximizing the melting of the powder.

### Technical Solution

In one aspect, there is provided a 3D printer having a variable laser irradiation device, comprising: a powder supplying unit configured to accommodate a powder therein and supply the powder for forming a product; and a product forming unit located at one side of the powder supplying unit to irradiate a laser to the powder supplied from the powder supplying unit and sinter the powder so that a 3D product is formed, wherein the laser irradiation device for irradiating the laser to the powder is installed at an inner top end of a case that accommodates the powder supplying unit and the product forming unit, and the laser irradiation device is movable in the front, rear, left and right directions based on a top surface of an output bed of the product forming unit on which the powder supplied from the powder supplying unit spreads and in the upper and lower directions above the top surface of the output bed.

Also, the laser irradiation device may include a variable lens so that a focal distance of the irradiated laser is variable.

Moreover, the variable lens may be pivotally coupled to the laser irradiation device so that an irradiation angle of the laser irradiated from the laser irradiation device is adjustable.

Further, the powder supplying unit may include: a powder accommodation chamber having a hollow shape to accommodate a powder therein; a feeding plate configured to move up and down inside the powder accommodation chamber according to a preset program so that the accommodated powder is partially exposed at a top end of the powder accommodation chamber; and a transporting unit configured to transport the powder, exposed at the top end of the powder accommodation chamber by the feeding plate, toward the product forming unit, and the product forming unit may include: a product forming chamber having a hollow shape and located at one side of the powder accommodation chamber; and an output bed configured to move up and down inside the product forming chamber according to a preset program so that the powder transported by the transporting unit spreads thereon.

In addition, the transporting unit may include: a moving member spaced upward from the top end of the powder accommodation chamber and the top surface of the output bed of the product forming unit and provided to move from the powder accommodation chamber toward the product forming chamber; and a compacting member extending downward from a bottom end of the moving member to push the powder exposed at the top end of the powder accommodation chamber toward the product forming chamber so that the powder on the output bed is flattened.

Moreover, a powder retrieving unit having a hollow shape may be disposed at a side opposite to the powder supplying unit based on the product forming unit, and among the powder supplied from the powder accommodation chamber to the product forming chamber by the transporting unit, a powder not sintered may be retrieved to the powder retrieving unit by the transporting unit.

Further, the powder retrieving unit may have an inner shape whose width is gradually narrowed from an upper portion thereof to a middle portion thereof and is gradually broadened from the middle portion to a lower portion thereof, and a filter may be provided at the middle portion to separate a useable powder.

Meanwhile, according to the second viewpoint of the present disclosure, there is provided a 3D printer having a heating device, comprising: a powder supplying unit configured to accommodate a powder therein and supply the powder for forming a product; and a product forming unit configured to irradiate a laser to the powder supplied from the powder supplying unit and sinter the powder so that a 3D product is formed, wherein the powder supplying unit has a hopper form, wherein a first heater for generating heat is installed at the powder supplying unit to preheat a powder supplied to an output bed of the product forming unit and post-heat a powder stacked on the output bed of the product forming unit, and wherein a second heater is installed at the output bed of the product forming unit to generate heat so that the heat and humidity of the stacked powder and the surface temperature of the output bed are kept constantly.

In addition, a screw may be installed in the powder supplying unit to prevent the powder from being agglomerated.

Moreover, the first heater may include a UV laser, and the UV laser may be provided at an outlet of the powder supplying unit through which the powder is discharged.

Further, the second heater may include an IR lamp or a heating coil, which is mounted inside the output bed.

In addition, the 3D printer may further comprise a third heater installed at an inner top end of a case that accommodates the powder supplying unit and the product forming unit, to generate heat so that an internal temperature of the case is kept constantly.

Moreover, the third heater may include: a lamp for generating heat; and a reflecting mirror pivotally installed at one side of the lamp to reflect the heat generated from the lamp to a required portion.

Further, a plurality of temperature sensors may be installed in each region inside the case, and the plurality of temperature sensors may detect a temperature of each region inside the case and transmit a signal to the reflecting mirror, so that the reflecting mirror reflects the heat to a region having a low temperature inside the case.

Meanwhile, according to the third viewpoint of the present disclosure, there is also provided a 3D printer having a binder jetting unit, comprising: a powder supplying unit configured to accommodate a powder therein and supply the powder for forming a product; and a product forming unit located at one side of the powder supplying unit to irradiate a laser to the powder supplied from the powder supplying unit and sinter the powder so that a 3D product is formed, wherein the powder supplying unit for supplying the powder is disposed at an upper portion of one side of an output bed of the product forming unit, and a binder jetting unit is disposed at an upper portion of the other side of the output bed, which is opposite to the powder supplying unit, to discharge a binder only to a region to which laser is to be irradiated to melt the powder, and wherein the powder supplying unit supplies the powder to the output bed while moving from one side to the other side of the output bed and then stops, the powder supplying unit and the binder jetting unit located at the other side of the output bed move together from the other side to one side of the output bed and stop after discharging the binder to a powder region in which the powder is to be melted in a state where the powder supplying unit stops the supply of powder, and a laser is irradiated to the powder region to which the binder is discharged so that the powder is melted and sintered, the above processes being repeated to output a final product.

In addition, the binder jetting unit may have a container form with a bottom surface through which a plurality of fine pores are formed, and a binder made of a resin may be sprayed through the plurality of fine pores in a liquid discharging manner.

Moreover, a cleaning space for cleaning the binder jetting unit may be formed in a groove form at the product forming unit located near the other side of the output bed, and when the final product is formed, the binder jetting unit may be located in the cleaning space to be cleaned.

Further, the powder may be a powder of any one of carbon, ceramic, polymer and metal.

In addition, a first heater made having a UV laser for generating heat may be installed at the powder supplying unit to preheat a powder supplied to the output bed of the product forming unit and post-heat a powder stacked on the output bed of the product forming unit.

Moreover, a second heater having an IR lamp or a heating coil may be mounted inside the output bed of the product forming unit to generate heat so that the heat and humidity of the stacked powder and the surface temperature of the output bed are kept constantly.

Further, a third heater may be installed at an inner top end of a case that accommodates the powder supplying unit and the product forming unit, to generate heat so that an internal temperature of the case is kept constantly, and the third heater may include a lamp for generating heat, and a reflecting mirror pivotally installed at one side of the lamp to reflect the heat generated from the lamp to a required portion.

In addition, a plurality of temperature sensors may be installed in each region inside the case, and the plurality of temperature sensors may detect a temperature of each region inside the case and transmit a signal to the reflecting mirror, so that the reflecting mirror reflects the heat to a region having a low temperature inside the case.

### Advantageous Effects

According to the above, the present disclosure has the following effects.

In the present disclosure, a laser irradiation device is installed at an inner top end of the case accommodating a powder supplying unit and a product forming unit, and the laser irradiation device is provided to be movable in the front, back, left and right direction based on the top surface of the output bed of the product forming unit and in the upper and lower directions above the top surface of the output bed, along which the powder supplied from the powder supplying unit spreads. Also, a variable lens is pivotally coupled to the laser irradiation device so that an irradiation angle of the laser irradiated from the laser irradiation device may be adjustable. By doing so, the laser may be irradiated to an accurate spot, and thus an elaborate three-dimensional product may be output.

In addition, in the present disclosure, a powder retrieving unit having a hollow shape is disposed at a side opposite to the powder supplying unit based on the product forming unit, and among the powder supplied to the product forming chamber from the powder accommodation chamber by the transporting unit, the powder not sintered is retrieved to the powder retrieving unit by the transporting unit. Thus, it is possible to prevent the powder from being wasted.

Moreover, in the present disclosure, the inner shape of the powder retrieving unit becomes narrower from the upper portion to the middle portion thereof, and becomes wider from the middle portion to the lower portion thereof. Also, a filter is provided at the middle portion so that a usable powder is separated. By doing so, it is possible to increase the powder retrieving efficiency.

Further, in the present disclosure, a first heater is installed at the powder supplying unit to preheat when the powder is supplied to the output bed of the product forming unit and to generate heat so that the powder stacked on the output bed of the product forming unit post-heated. By doing so, the powder may be smoothly supplied without being agglomerated by moisture or the like, and thus may be uniformly stacked on the output bed.

In addition, in the present disclosure, a second heater for generating heat to the output bed of the product forming unit is installed so that the heat and humidity of the stacked powder and the surface temperature of the output bed are kept constantly.

Moreover, in the present disclosure, a third heater for generating heat is installed at the inner top end of the case that accommodates the powder supplying unit and the product forming unit, so that temperature deviation does not occur inside the case including the product forming chamber that forms a product, thereby improving the quality of the output product.

Further, in the present disclosure, the third heater includes a lamp for generating heat and a reflecting mirror pivotally installed at one side of the lamp to reflect the heat generated from the lamp to a required portion. Also, a plurality of temperature sensors are installed for each region in the case, and the plurality of temperature sensors sense the temperature of each region in the case and then transmit a signal to the reflecting mirror so that the reflecting mirror reflects the heat toward a region in the case where the temperature is low. Accordingly, it is possible to minimize the occurrence of distortion or cracking of a final product by keeping the temperature inside the case constantly.

In addition, in the present disclosure, a powder supplying unit for supplying powder is disposed at an upper portion of one side of the output bed of the product forming unit, and a binder jetting unit for discharging a binder only in a region where laser is irradiated to melt the powder is disposed at an upper portion of the other side of the output bed, which is opposite to the powder supplying unit. Also, the powder supplying unit supplies powder to the output bed while moving from one side of the output bed to the other side and then stops, and the powder supplying unit and the binder jetting unit located at the other side of the output bed move together from the other side of the output bed to one side thereof and stop after discharging the binder to a powder region to be melted in a state where the powder supplying unit stops the supply of powder. Also, the laser is irradiated to the powder region where the binder is discharged so that the powder is melted and sintered. The above processes are repeated to output a final product. As a result, the binding force between the powder and the powder applied to the output bed is enhanced, and the melting of the powder is maximized, thereby increasing the durability of the output product.

Moreover, in the present disclosure, the product forming unit located near the other side of the output bed has a cleaning space formed in a groove form to clean the binder jetting unit, so that when a final product is formed, the binder jetting unit is located in the cleaning space to clean the final product. Thus, it is possible to prevent a situation that the binder made of a resin is hardened after a predetermined time so that the work is not smoothly performed.

### BRIEF DESCRIPTION OF THE DRAWINGS

FIG. 1 is a diagram schematically showing a 3D printer having a variable laser irradiation device according to the first viewpoint of the present disclosure.

FIG. 2 is a diagram showing that a laser irradiation device of FIG. 1 moves in the X-axis direction inside a case and irradiates a laser.

FIG. 3 is a diagram showing that a variable lens is coupled to the laser irradiation device of FIG. 1 to change a laser irradiation direction.

FIG. 4 is a diagram showing that a laser irradiation area is changed when the laser irradiation device of FIG. 3 moves in the Z-axis direction (the upper and lower directions inside the case).

FIG. 5 is a diagram showing a modified example of FIG. 4.

FIG. 6 is a diagram showing a laser irradiation area according to the height of the Z axis, when the laser irradiation device of FIG. 5 moves in the Z-axis direction (the upper and lower directions inside the case).

FIG. 7 is a diagram showing a powder supplying unit at which a first heater is installed and an output bed at which a second heater is installed, employed at the 3D printer having a heating device according to the second viewpoint of the present disclosure.

FIG. 8 is an enlarged view showing the powder supplying unit of FIG. 7.

FIG. 9 is a diagram schematically showing an example of the second heater installed at the output bed of FIG. 7.

FIG. 10 is a diagram showing a state where a third heater is installed inside the case, employed at the 3D printer having a heating device according to the second viewpoint of the present disclosure, and a state where a plurality of temperature sensors are installed inside the case of the 3D printer.

FIG. 11 is a diagram schematically showing another example of the second heater installed at the output bed of FIG. 7.

FIG. 12 is a diagram schematically showing the 3D printer having a binder jetting unit according to the third viewpoint of the present disclosure, in a state where the powder supplying unit and the binder jetting unit are disposed above the output bed.

FIG. 13 is a plane view of FIG. 12.

FIG. 14 is a diagram showing a state where a cleaning space of the binder jetting unit is formed at the 3D printer having a binder jetting unit, depicted in FIG. 12.

FIG. 15A is a diagram schematically showing the binder jetting unit of FIG. 12, and FIG. 15B is a diagram showing a bottom surface of the binder jetting unit of FIG. 15(a).

### MODE FOR CARRYING OUT THE INVENTION

Hereinafter, preferred embodiments of a 3D printer according to the first to third viewpoints of the present disclosure will be described in detail with reference to the accompanying drawings. For reference, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

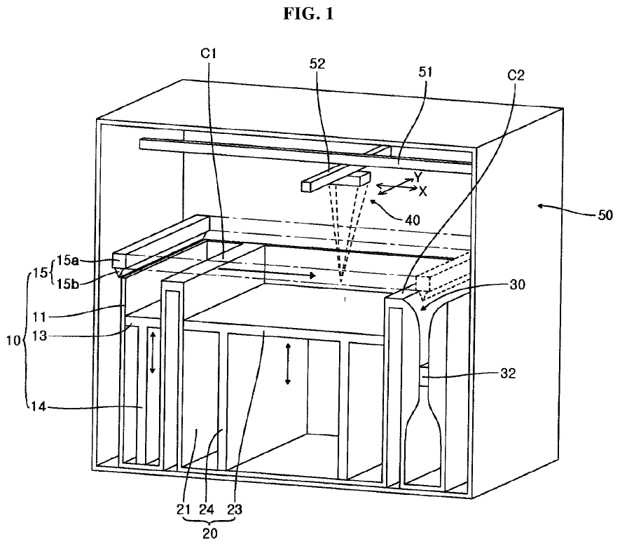

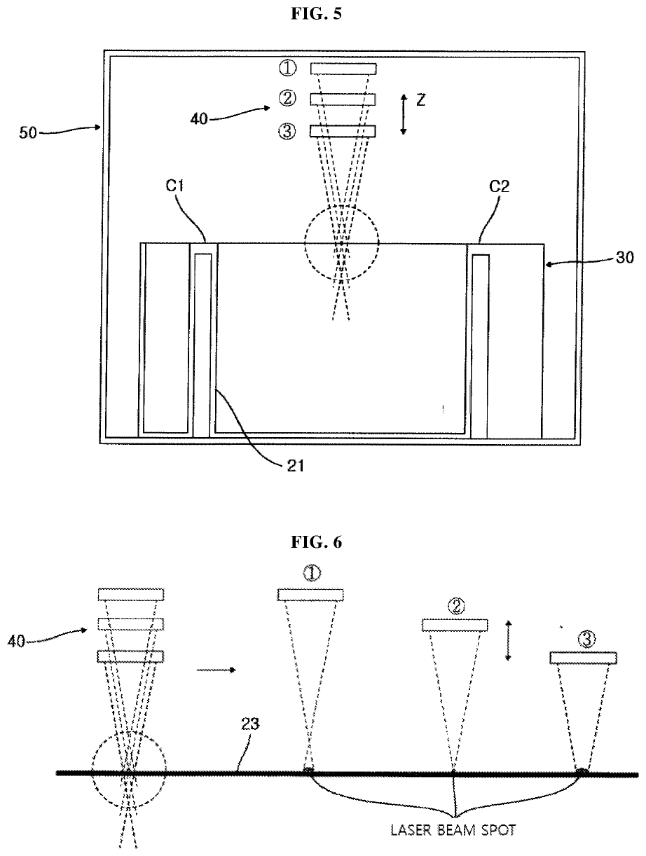

FIGS. 1 to 6 are diagrams showing a 3D printer having a variable laser irradiation device according to the first viewpoint of the present disclosure.

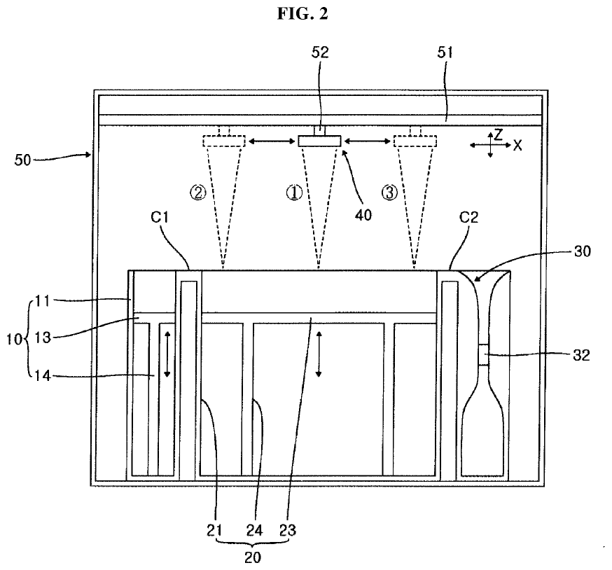

As shown in FIGS. 1 and 2, the 3D printer having a variable laser irradiation device according to the first viewpoint of the present disclosure incudes a powder supplying unit 10, a product forming unit 20 and a laser irradiation device 40.

The powder supplying unit 10 is used to supply a powder for forming product in a state of accommodating the powder therein, and includes a powder accommodation chamber 11, a feeding plate 13 and a transporting unit 15.

The powder accommodation chamber 11 has a hollow shape and accommodates a powder therein. The powder accommodation chamber 11 may have a barrier shape protruding upward at both sides and a rear side thereof, except for a front side thereof that is a first connection portion C1 connected to the product forming unit 20.

The barrier may prevent the powder exposed at a top end of the powder accommodation chamber 11 from falling out of the powder accommodation chamber 11.

The feeding plate 13 exposes a part of the accommodated powder by moving up and down inside the powder accommodation chamber 11 according to a preset program to expose a part of the powder at the top end of the powder accommodation chamber 11. The feeding plate 13 moves up and down by means of a first driving unit 14 coupled to a lower portion thereof.

The first driving unit 14 includes a first lifting rod (not shown) having one end fixed to the lower portion of the feeding plate 13 and the other end extending downward from the inside of the powder accommodation chamber 11, and a first driving motor (not shown) for moving the first lifting rod up and down. Also, in a state where at least one first guide (not shown) is disposed around the first lifting rod, the first driving unit 14 moves up and down together with the first lifting rod to guide the movement of the feeding plate 13.

The transporting unit 15 transports the powder exposed at the top end of the powder accommodation chamber 11 by the feeding plate 13 toward the product forming unit 20. The transporting unit 15 is repeatedly moved forward and backward along the direction connecting the powder accommodation chamber 11 and the product forming chamber 21 in a state of being disposed at the top end of the powder accommodation chamber 11.

The transporting unit 15 is located at a rear end of the powder accommodation chamber 11 when the feeding plate 13 moves up. If the feeding plate 13 completely moves up and a predetermined amount of powder is exposed at the top end of the powder accommodation chamber 11, the transporting unit 15 starts transporting the powder from the rear to the front of the powder accommodation chamber 11.

As described above, the movement of the transporting unit 15 functions to push the powder exposed at the top end of the powder accommodation chamber 11 toward the product forming chamber 21.

By doing so, a certain amount of powder may be periodically supplied so as to be sintered by exposing to the laser on the product forming unit 20.

The transporting unit 15 includes a moving member 15a spaced upward from the top end of the powder accommodation chamber 11 and a top surface of an output bed 23 of the product forming chamber 20 to move from the powder accommodation chamber 11 toward the product forming chamber 21, and a compacting member 15b extending downward from a bottom end of the moving member 15a to push the powder exposed at the top end of the powder accommodation chamber 11 toward the product forming chamber 21 so that the powder on the output bed 23 is flattened.

The product forming unit 20 is located at one side of the powder supplying unit 10 and is used for forming a 3D product by irradiating a laser to the powder supplied from the powder supplying unit 10 so that the powder is sintered. The product forming unit 20 includes a product forming chamber 21 and an output bed 23.

The product forming chamber 21 has a hollow shape and is located at one side of the powder accommodation chamber 11. The product forming chamber 21 defines a space in which the powder supplied from the powder supplying unit 10 is sintered by a laser to form a product with a desired shape.

The product forming chamber 21 may be connected to the top end of the powder accommodation chamber 11 through the first connection portion C1 so that the powder may be supplied smoothly. The first connection portion C1 may be formed to be inclined downward from the powder accommodation chamber 11 to the product forming chamber 21, as an example.

The output bed 23 is configured to move up and down inside the product forming chamber 21 according to a preset program, and the powder transported by the transporting unit 15 spreads on the outer bed 23. The output bed 23 is movable up and down by means of a second driving unit 24 coupled to a lower portion thereof.

The second driving unit 24 includes a second lifting rod (not shown) having one end fixed to the lower portion of the output bed 23 and the other end extending downward inside the product forming chamber 21, and a second driving motor (not shown) for moving the second lifting rod up and down. In a state where at least one second guide (not shown) is disposed around the second lifting rod, the second driving unit 24 moves up and down together with the second lifting rod to guide the movement of the output bed 23.

The laser irradiation device 40 for irradiating a laser to the powder is installed at an inner top end of a case 50 that accommodates the powder supplying unit 10 and the product forming unit 20. The laser irradiation device 40 is configured to be movable in the front, rear, left and right directions based on the top surface of the output bed 23 of the product forming unit 20 on which the powder supplied from the powder supplying unit 10 spreads and in the upper and lower directions above the top surface of the output bed 23.

That is, assuming that an axis of the direction in which powder is supplied from the powder supplying unit 10 to the product forming unit 20 is an X axis, an axis orthogonal to the X axis is a Y axis, and an axis of a vertical height direction of the case 50 is a Z axis, an X-axis frame 51, a Y-axis frame 52 and a Z-axis frame 53 are installed at the inner top end of the case 50, respectively.

The X-axis frame 51, the Y-axis frame 52 and the Z-axis frame 53 may be implemented as a linear motion (LM) guide. The laser irradiation device 40 may be coupled to any one of the X-axis frame 51, the Y-axis frame 52 and the Z-axis frame 53 to be movable in the front, rear, left and right directions based on the top surface of the output bed 23 and in the upper and lower directions above the top surface of the output bed 23. For example, the laser irradiation device 40 may be implemented as a Galvano mirror system.

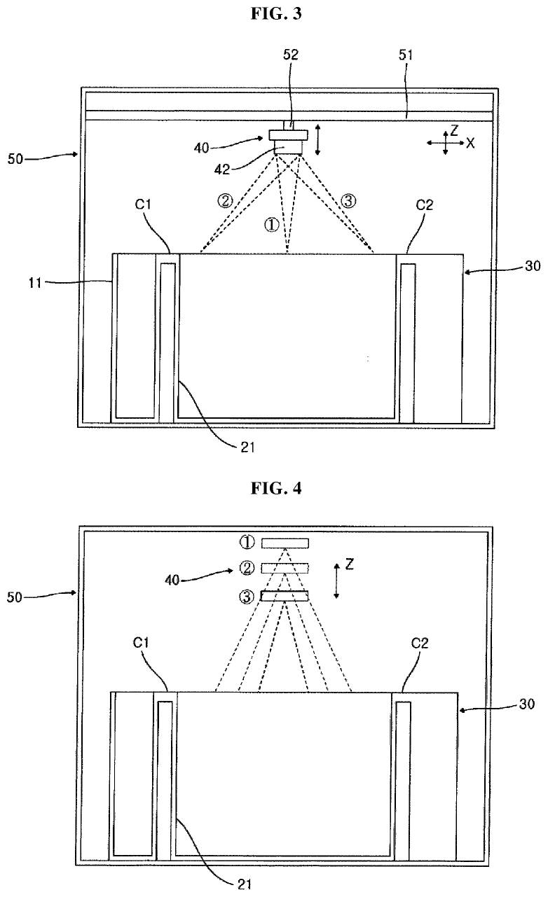

Moreover, as shown in FIG. 3, the laser irradiation device 40 may include a variable lens 42 for varying a focal distance of the laser to be irradiated. The variable lens 42 is pivotally coupled to the laser irradiation device 40 so that an irradiation angle of the irradiated laser may be adjusted.

As described above, the laser irradiation device 40 is installed at the inner top end of the case 50 that accommodates the powder supplying unit 10 and the product forming unit 20, and the laser irradiation device 40 is provided to be movable in the front, rear, left and right directions based on the top surface of the output bed 23 of the product forming unit 20 on which the powder supplied from the powder supplying unit 10 spreads and in the upper and lower directions above the top surface of the output bed 23, and also the variable lens 42 is pivotally coupled to the laser irradiation device 40 so that an irradiation angle of the laser irradiated from the laser irradiation device 40 may be adjusted. By doing so, the laser may be accurately irradiated to a spot to which the laser should be irradiated, thereby outputting an elaborate three-dimensional product (see FIGS. 3 to 6).

Meanwhile, as shown in FIGS. 1 and 2, a powder-retrieving unit 30 having a hollow shape may be disposed at a side opposite to the powder supplying unit 10 based on the product forming unit 20. Among the powder supplied from the powder accommodation chamber 11 to the product forming chamber 21 by the transporting unit 15, the powder that is not sintered is retrieved to the powder retrieving unit 30 through a second connection portion C2 by the transporting unit 15.

The inside of the powder retrieving unit 30 has a sandglass shape whose width is gradually narrowed from an upper portion to a middle portion thereof and is gradually broadened from the middle portion to a lower portion thereof. A filter 32 is provided at the middle portion to separate a useable powder.

As described above, the powder retrieving unit 30 having a hollow shape is disposed at a side opposite to the powder forming unit 10 based on the product forming unit 20, and among the powder supplied from the powder accommodation chamber 11 to the product forming chamber 21 by the transporting unit 15, the powder not sintered is retrieved to the powder retrieving unit 30 by the transporting unit 15. By doing so, it is possible to prevent the powder from being wasted.

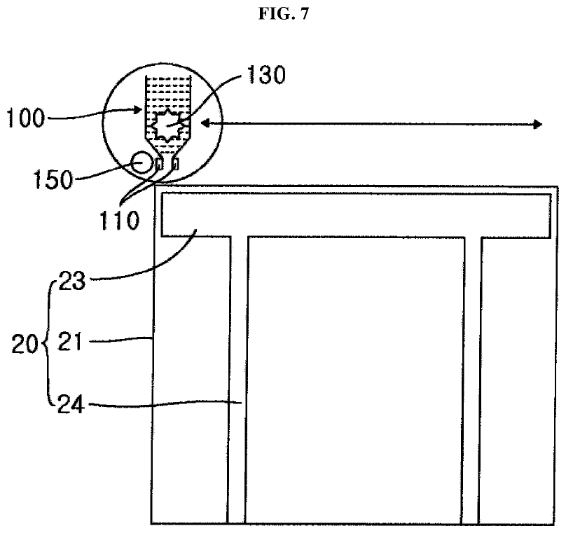

FIGS. 7 to 11 are diagrams showing a 3D printer having a heating device according to the second viewpoint of the present disclosure.

The 3D printer having a heating device according to the second viewpoint of the present disclosure includes a powder supplying unit 100 and a product forming unit 20.

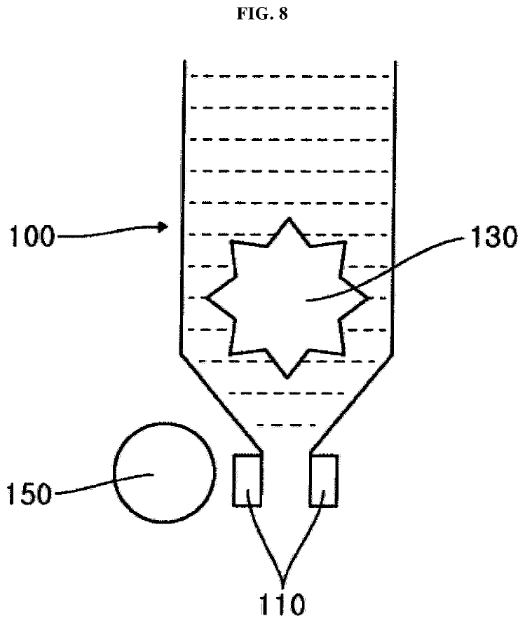

As shown in FIGS. 7 and 8, the powder supplying unit 100 supplies a powder for forming a product in a state of accommodating the powder therein. The powder supplying unit 100 has a hopper shape and is configured to discharge and supply the powder while linearly moving above the output bed 23 of the product forming unit 20.

A first heater 110 for generating heat is installed to preheat the powder when the powder is supplied to the output bed 23 of the product forming unit 20 and post-heat the powder stacked on the output bed 23 of the product forming unit 20.

The first heater 110 includes a UV (ultraviolet) laser and is provided at an outlet of the powder supplying unit 100 having a hopper shape through which the powder is discharged.

In addition, a screw 130 may be installed inside the powder supplying unit 100 to prevent the powder from being agglomerated.

By installing the first heater 110 for preheating the powder when the powder is supplied to the output bed 23 of the product forming unit 20 and post-heating the powder stacked on the output bed 23 of the product forming unit 20, the powder may be supplied smoothly without being agglomerated by moisture or the like and thus may be uniformly stacked on the output bed 23.

A rotating roller 150 is installed at the rear of the powder supplying unit 100 having a hopper shape (at a side opposite to the side at which the powder is supplied) so that the powder supplied from the powder supplying unit 100 to the output bed 23 may be flattened on the output bed 23. The rotating roller 150 linearly moves on the output bed 23 integrally with the powder supplying unit 100.

The product forming unit 20 is used for irradiating a laser to the powder supplied from the powder supplying unit 100 so that the powder is sintered to form a 3D product. The product forming unit 20 includes a product forming chamber 21 and an output bed 23.

The product forming chamber 21 has the same configuration as that of the first viewpoint described above and thus will not be described again.

A second heater 26 is installed at the output bed 23 of the product forming unit 20 to generate heat so that the heat and humidity of the powder stacked on the output bed 23 and the surface temperature of the output bed 23 may be kept constantly.

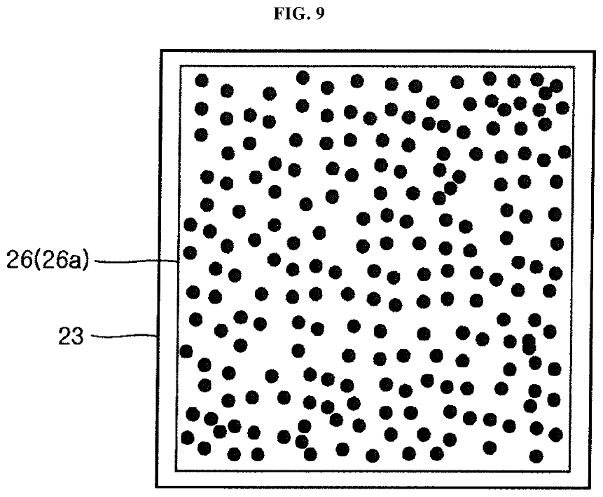

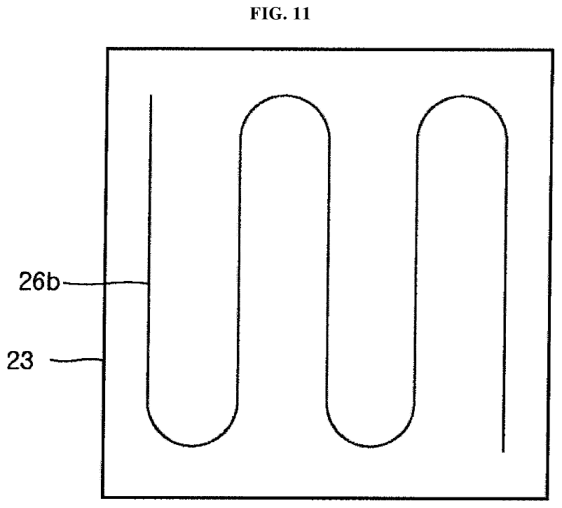

The second heater 26 may be provided in a form of an IR lamp 26a (see FIG. 9) or a heating coil 26b (see FIG. 11) and be installed inside the output bed 23.

Meanwhile, as another embodiment, the powder supplying unit 10 may include a powder accommodation chamber 11, a feeding plate 13 and a transporting unit 15 as in the first viewpoint described above.

At this time, a first heater for generating heat is installed at the powder supplying unit 10 to preheat the powder when the powder is supplied to the output bed 23 of the product forming unit 20. The first heater may be provided in the form of an IR lamp or a heating coil and be installed inside the feeding plate 13.

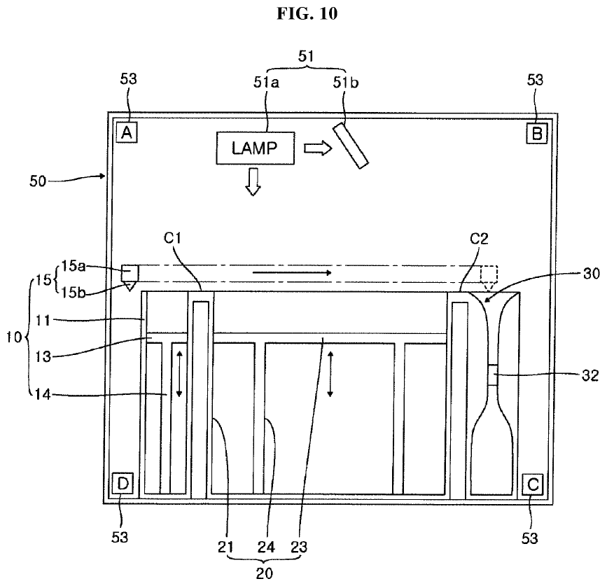

In order to keep the internal temperature of the case 50 constantly, a third heater 51 for generating heat may be further installed at the inner top end of the case 50 that accommodates the powder supplying unit 10 and the product forming unit 20, as shown in FIG. 10.

The third heater 51 includes a lamp 51a for generating heat and a reflecting mirror 51b positioned at one side of the lamp 51a and pivotally installed to reflect the heat generated from the lamp 51a to a required portion.

By installing the third heater 51 for generating heat at the inner top end of the case 50 accommodating the powder supplying unit 10 and the product forming unit 20, a temperature deviation may not be generated inside the case 50 including the product forming chamber 21 for forming a product, thereby improving the quality of an output produce.

In addition, a plurality of temperature sensors 53 are installed in each region inside the case 50. The plurality of temperature sensors 53 detect the temperature of each region inside the case 50 and then transmit a signal to the reflecting mirror 51b, so that the reflecting mirror 51b reflects the heat toward a region with a low temperature region inside the case 50.

A driving motor (not shown) is coupled to the reflecting mirror 51b, and the driving motor is connected to the plurality of temperature sensors 53 to receive an electrical signal therefrom and adjusts a pivoting angle of the reflecting mirror 51b. At this time, the driving motor may be a step motor.

Accordingly, the temperature inside the case 50 may be kept constantly, and thus it is possible to minimize the distortion or cracking of a final product.

Meanwhile, the 3D printer having a heating device according to the second disclosure of the present disclosure may include a powder retrieving unit 30 as in the first viewpoint described above.

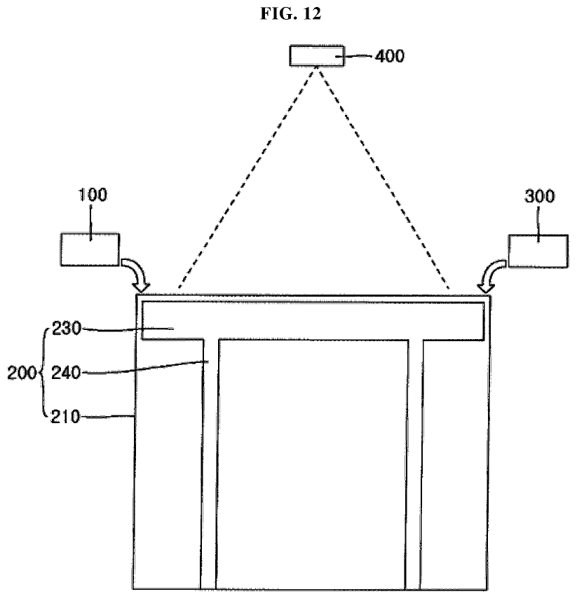

FIGS. 12 to 15B are diagrams showing a 3D printer having a binder jetting unit according to the third viewpoint of the present disclosure.

The 3D printer having a binder jetting unit according to the third viewpoint of the present disclosure includes a powder supplying unit 100, a product forming unit 200 and a binder jetting unit 300.

The powder supplying unit 100 supplies a powder for forming a product in a state of accommodating the powder therein. The powder supplying unit 100 has a hopper shape and is configured to discharge and supply the powder while linearly moving above the output bed 230 of the product forming unit 200.

A first heater (not shown) for generating heat is installed to preheat the powder when the powder is supplied to the output bed 230 of the product forming unit 200 and post-heat the powder stacked on the output bed 230 of the product forming unit 200.

The first heater includes a UV (ultraviolet) laser and is provided at an outlet of the powder supplying unit 100 having a hopper shape through which the powder is discharged.

In addition, a screw may be installed inside the powder supplying unit 100 to prevent the powder from being agglomerated.

The product forming unit 200 is positioned at one side of the powder supplying unit 100 to irradiate a laser to the powder supplied from the powder supplying unit 100 so that the powder is sintered to form a 3D product. The product forming unit 200 includes a product forming chamber 210 and an output bed 230.

The product forming chamber 210 has a hollow shape and is located at one side of the powder accommodation chamber. The product forming chamber 210 defines a space in which the powder supplied from the powder supplying unit 100 is sintered by a laser to form a product with a desired shape.

The product forming chamber 210 may be connected to the top end of the powder accommodation chamber through the first connection portion C1 so that the powder may be supplied smoothly. The first connection portion C1 may be formed to be inclined downward from the powder accommodation chamber to the product forming chamber 210, as an example.

The output bed 230 is configured to move up and down inside the product forming chamber 210 according to a preset program, and the powder transported by the transporting unit spreads on the outer bed 230. The output bed 230 is movable up and down by means of a second driving unit 240 coupled to a lower portion thereof.

The second driving unit 240 includes a second lifting rod (not shown) having one end fixed to the lower portion of the output bed 230 and the other end extending downward inside the product forming chamber 210, and a second driving motor (not shown) for moving the second lifting rod up and down. In a state where at least one second guide (not shown) is disposed around the second lifting rod, the second driving unit 240 moves up and down together with the second lifting rod to guide the movement of the output bed 230.

At this time, similar to the second viewpoint, a second heater in the form of an IR lamp or a heating coil may be provided at the output bed 230 of the product forming unit 200 to generate heat so that the heat and humidity of the stacked powder and the surface temperature of the output bed 230 may be kept constantly.

Meanwhile, as shown in FIG. 12, the powder supplying unit 100 for supplying powder is disposed at an upper portion of one side of the output bed 230 of the product forming unit 200, and a binder jetting unit 300 is disposed at an upper portion of the other side of the output bed 230, which is opposite to the powder supplying unit 100, to irradiate a laser so that a binder B is discharged only to a region where the powder is to be melted.

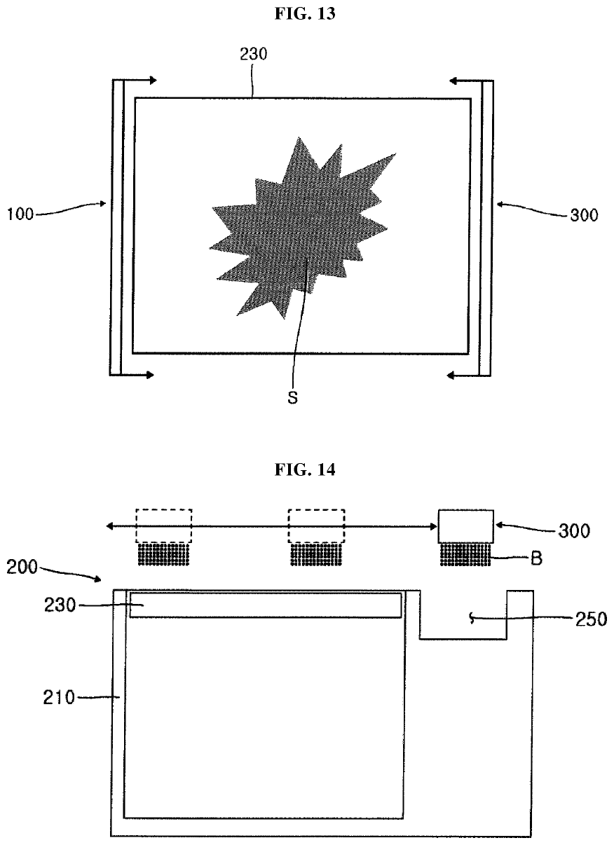

Accordingly, the powder supplying unit 100 supplies powder to the output bed 230 while moving from one side of the output bed 230 to the other side thereof and then stops, and the powder supplying unit 100 and the binder jetting unit 300 located at the other side of the output bed 230 move together from the other side to one side of the output bed 230 and stop after discharging the binder B to a powder region in which the powder is to be melted in a state where the powder supplying unit 100 stops the supply of powder. Also, as shown in FIG. 13, a laser is irradiated to the powder region S to which the binder B is discharged so that the powder is melted and sintered. The above processes are repeated to output a final product.

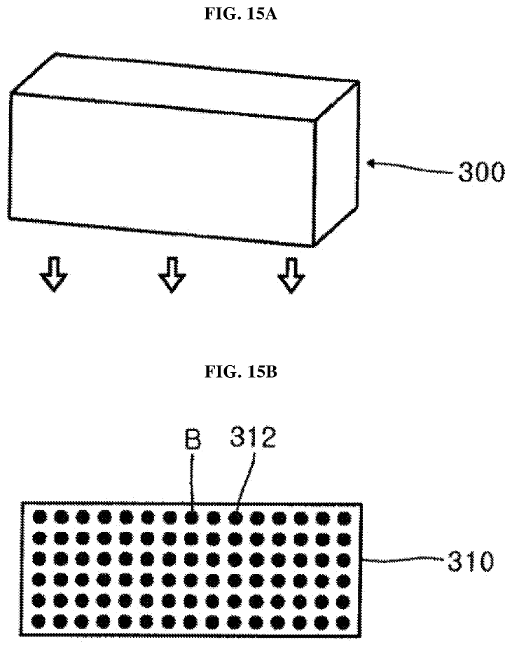

As shown in FIGS. 15A and 15B, the binder jetting unit 300 has a container form with a bottom surface 310 through which a plurality of fine pores 312 are formed, and the binder B made of a resin is sprayed through the plurality of fine pores 312 in a liquid discharging manner.

By discharging the binder B to the powder as above, the binding force between the powder and the powder applied to the output bed 230 may be enhanced, and the melting of the powder may be maximized to increase the durability of an output product.

Meanwhile, as shown in FIG. 14, a cleaning space 250 for cleaning the binder jetting unit 300 is provided in a groove form at the product forming unit 200 located near the other side of the output bed 230. If a final product is formed, the binder jetting unit 300 is positioned in the cleaning space 250 to be cleaned.

A predetermined cleaning liquid is accommodated in the cleaning space 250. If the binder jetting unit 300 is put into the cleaning space 250, the binder jetting unit 300 may be cleaned by the cleaning liquid.

Alternatively, a brush or the like may be installed in the cleaning space 250 to clean the binder jetting unit 300, and various other configurations may be used.

By cleaning the binder jetting unit 300 as described above, it is possible to prevent a situation that the binder B made of a resin is hardened after a predetermined time so that the work is not smoothly performed.

At this time, the powder accommodated in the powder supplying unit 100 may be a powder of any one of carbon, ceramic, polymer and metal.

Moreover, similar to the second viewpoint described above, a third heater may be disposed at the inner top end of the case that accommodates the powder supplying unit 100 and the product forming unit 200. The third heater includes a lamp generating heat to keep the internal temperature of the case constantly, and a reflecting mirror positioned at one side of the lamp and pivotally installed to reflect the heat generated from the lamp to a required portion.

In addition, a plurality of temperature sensors are installed in each region inside the case. The plurality of temperature sensors detect the temperature of each region inside the case and then transmit a signal to the reflecting mirror, so that the reflecting mirror reflects the heat toward a region with a low temperature region inside the case.

A driving motor is coupled to the reflecting mirror, and the driving motor is connected to the plurality of temperature sensors to receive an electrical signal therefrom and adjusts a pivoting angle of the reflecting mirror. At this time, the driving motor may be a step motor.

The present disclosure is not limited to the above embodiments and the accompanying drawings, and it will be apparent to those skilled in the art that various changes, substitutions and modifications can be made thereto without departing from the technical idea of the present disclosure.

1. A 3D printer having a heating device comprising:
a powder supplying unit configured to accommodate a powder therein and supply the powder for forming a product; and
a product forming unit configured to irradiate a laser to the powder supplied from the powder supplying unit and sinter the powder so that a 3D product is formed,
wherein the powder supplying unit has a hopper form,
wherein a first heater for generating heat is installed at the powder supplying unit to preheat a powder supplied to an output bed of the product forming unit and post-heat a powder stacked on the output bed of the product forming unit,
wherein a second heater is installed at the output bed of the product forming unit to generate heat so that the heat and humidity of the stacked powder and the surface temperature of the output bed are kept constantly.

2. The 3D printer having a heating device of claim 1, wherein a screw is installed in the powder supplying unit to prevent the powder from being agglomerated.

3. The 3D printer having a heating device of claim 1, wherein the first heater includes a UV laser, and the UV laser is provided at an outlet of the powder supplying unit through which the powder is discharged.

4. The 3D printer having a heating device of claim 1, wherein the second heater includes an IR lamp or a heating coil, which is mounted inside the output bed.

5. The 3D printer having a heating device of claim 1, further comprising:
a third heater installed at an inner top end of a case that accommodates the powder supplying unit and the product forming unit, to generate heat so that an internal temperature of the case is kept constantly.

6. The 3D printer having a heating device of claim 5, wherein the third heater comprising:
a lamp for generating heat; and
a reflecting mirror pivotally installed at one side of the lamp to reflect the heat generated from the lamp to a required portion.

7. The 3D printer having a heating device of claim 6, wherein a plurality of temperature sensors are installed in each region inside the case, and the plurality of temperature sensors detect a temperature of each region inside the case and transmits a signal to the reflecting mirror, so that the reflecting mirror reflects the heat to a region having a low temperature inside the case.

8. The 3D printer having a heating device of claim 1,
wherein the powder supplying unit comprising:
a powder accommodation chamber having a hollow shape to accommodate a powder therein;
a feeding plate configured to move up and down inside the powder accommodation chamber according to a preset program so that the accommodated powder is partially exposed at a top end of the powder accommodation chamber; and
a transporting unit configured to transport the powder, exposed at the top end of the powder accommodation chamber by the feeding plate, toward the product forming unit,
wherein the product forming unit comprising:
a product forming chamber having a hollow shape and located at one side of the powder accommodation chamber; and
an output bed configured to move up and down inside the product forming chamber according to a preset program so that the powder transported by the transporting unit spreads thereon.

9. The 3D printer having a heating device of claim 8, wherein the transporting unit comprising:
a moving member spaced upward from the top end of the powder accommodation chamber and the top surface of the output bed of the product forming unit and provided to move from the powder accommodation chamber toward the product forming chamber; and
a compacting member extending downward from a bottom end of the moving member to push the powder exposed at the top end of the powder accommodation chamber toward the product forming chamber so that the powder on the output bed is flattened.

10. The 3D printer having a heating device of claim 9,
wherein a powder retrieving unit having a hollow shape is disposed at a side opposite to the powder supplying unit based on the product forming unit,
wherein among the powder supplied from the powder accommodation chamber to the product forming chamber by the transporting unit, a powder not sintered is retrieved to the powder retrieving unit by the transporting unit.

11. The 3D printer having a heating device of claim 10,
wherein the powder retrieving unit has an inner shape whose width is gradually narrowed from an upper portion thereof to a middle portion thereof and is gradually broadened from the middle portion to a lower portion thereof,
wherein a filter is provided at the middle portion to separate a useable powder.

12. The 3D printer having a heating device of claim 1, wherein the powder is a material selected from the group consisting of carbon, ceramic, polymer, and metal.
